(19) United States
(12) Patent Application Publication
(10) Pub. No.: US 2005/0012853 A1
(43) Pub. Date: Jan. 20, 2005

(54) [HANDHELD DEVICE FOR IMAGE CAPTURE]

(76) Inventor: JACK WANG, TAIPEI COUNTY (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,423

(22) Filed: Sep. 30, 2003

(30) Foreign Application Priority Data
Jul. 16, 2003 (TW) 92119360

(51) Int. Cl. H04N 5/225

(52) U.S. Cl. 348/376

(57) ABSTRACT

A handheld device for capturing image is provided, where a micro flat panel display serves as a viewfinder for capturing image as well as a display for displaying image, so that size and power consumption of the device are both significantly reduced. A structure with a Universal Serial Bus (USB) connector configures the device to directly hookup a USB interface of a computer, thus neither a cable nor an external stand is required for connection purpose. On the other hand, it is quite handy for a user to charge the device through USB as the device transmits data to a computer via direct connection.

### BACKGROUND OF INVENTION

1. Field of Invention

The present invention relates to an image capture device. More particularly, the present invention relates to a handheld image capture device.

2. Description of Related Art

As digital technology substantially proceeds and Internet and multi-media highly develop, it is desirable to digitize images accordingly. Digital Camera, Digital Video camera capture images directly as well as convert images to digital image data, so that to serve computers or other electronic appliances thereof to display, to perform Optical Character Recognition (i.e. OCR), to edit, to store and to output the digital images accordingly.

Comparing with conventional camera configured with film and video camera configured with tape, direct image capture via digital camera and digital video camera provides digital storage and editing, as well as finer image quality, and affordable price, whereas capture capability is significantly increased as electronics industry prosper rapidly.

Therefore it is a trend that digital camera and digital video camera progressively eliminate conventional camera and video.

However, it is known to the skilled in digital camera and digital video camera, as larger color flat panel display is used, a cable or external connector thus has to take place for transmitting data to computer. Furthermore, for larger color flat panel display consumes higher power, an external charger is required thereof.

### SUMMARY OF INVENTION

In the light of the foregoing issues, the invention provides a handheld image capture device, where a body of the device is downsized and power consumption is lowered accordingly. It is also relatively convenient that direct USB connection to computer and simultaneous charging are available, for a cable or an external connector is eliminated thereby.

In order to achieve the foregoing and other objects, the present invention provides a handheld image capture device comprising a body, an image processing circuit, and a power circuit. Wherein, the body at least configures an optical lens, a micro flat panel display and a USB connector. As to image processing circuit, it configures within the body so as to capture image via the optical lens to store the processed images through a USB connector that is coupled to a serial port connector. Thus the captured or stored images are free to be displayed via the micro flat panel display. On the other hand, the power circuit is coupled to the image processing circuit so as to supply power to the image processing circuit.

According to one preferred embodiment of this present invention, the power circuit of the handheld image capture device comprises a rechargeable battery, a charging circuit, and a dc/dc converting circuit. Where the charging circuit is coupled to the rechargeable battery and the aforesaid USB connector, so as to charge the battery via the USB, where as the dc/dc converting circuit is coupled to the rechargeable battery so as to supply power to the image processing circuit therein.

According to one preferred embodiment of this present invention, the micro flat panel display of the handheld image capture device features a diagonal size of 0.6 inch.

According to one preferred embodiment of this present invention, the image processing circuit of the handheld image capture device is capable of processing motion pictures, performing as a video camera thereby.

According to one preferred embodiment of this present invention, the image processing circuit of the handheld image capture device is capable of processing still picture, performing as a camera thereby.

According to one preferred embodiment of this present invention, the body of the handheld image capture device further comprises a microphone, whereas the image processing circuit manages to process audio signal, serving as a recorder thereby.

According to one preferred embodiment of this present invention, the body of the handheld image capture device further comprises a headphone jack, whereas the image processing circuit manages to process Moving Pictures Experts Group-1 Audio Layer 3, or MP3 audio signals, serving as a MP3 recorder thereby.

The present invention provides a handheld image capture device comprising a body, an image processing circuit, a rechargeable battery, a charging circuit, and a dc/dc converting circuit, wherein the body configures at least an optical lens, a display, and a USB connector. Whereas the image processing circuit configuring inside of the body captures images via the optical lens, as well as processes and stores the images via USB that is coupling to the USB connector therein, or displays the captured or stored images via the display. The charging circuit is coupled to the rechargeable battery and the USB connector, so as to charge the rechargeable battery via USB power supply thereby. The dc/dc converting circuit is coupled to the rechargeable battery and the image processing circuit so as to supply power thereto.

According to one preferred embodiment, the display of the handheld image capture device is a micro flat panel display that features 0.6 inch in diagonal size.

According to one preferred embodiment, the image processing circuit of the handheld image capture device manages to process motion pictures, serving as a video camera thereby.

According to one preferred embodiment, the image processing circuit of the handheld image capture device manages to process still pictures, serving as a camera thereby.

According to one preferred embodiment, the body of the handheld image capture device further comprises a microphone, whereas the image processing circuit manages to process audio signals, serving as a recorder thereby.

According to one preferred embodiment, the body of the handheld image capture device further comprises a headphone jack, whereas the image processing circuit manages to process MP3 audio signals, serving as a MP3 player thereby.

In light of the foregoing description, the present invention provides a handheld image capture device that narrows the body dimension and lowers power consumption, for having the charging circuit performing via the USB power supply, featuring micro flat panel display, and configuring a USB connector on the body. An extra cable or an external stand being eliminated from connection to USB of a computer, it is thus superiorly convenient to perform data transmitting and electrical charging simultaneously.

These and other objects, features and advantages of the present invention will become apparent from the following detailed description of illustrative embodiments thereof, which is to be read in connection with the accompanying drawings.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a front view stereogram of the handheld image capture device according to one preferred embodiment of this invention.

FIG. 2 illustrates a back view stereogram of the handheld image capture device according to one preferred embodiment of this invention.

FIG. 3 illustrates a circuit block diagram of the handheld image capture device according to one preferred embodiment of this invention.

FIG. 4 illustrates a structure diagram of a micro flat panel display of the handheld image capture device according to one preferred embodiment of this invention.

FIG. 5 illustrates lens dimension to a micro flat panel display of the handheld image capture device according to one preferred embodiment of this invention.

### DETAILED DESCRIPTION

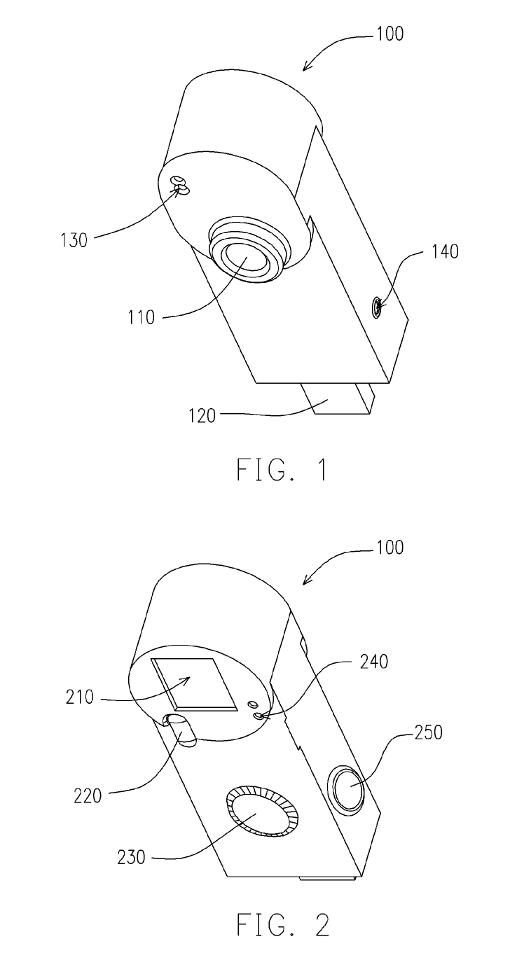

Referring to both FIGS. 1 and 2, a front view of structural stereogram of a handheld image capture device is illustrated in FIG. 1, whereas a back view of structural stereogram of a handheld image capture device is illustrated in FIG. 2 according to one preferred embodiment of the present invention.

As illustrated in the diagram, a body 100 of this handheld image capture device comprises at least an optical lens 110, a display (e.g. a micro flat panel display 210), and a Universal Serial Bus, or USB, connector 120. Moreover, additional features such as a microphone 130, a headphone jack 140, a zoom-in/zoom-out button 220, a mode knob 230, a Light Emitting Diode, or LED, indicator 240, and a shutter button 250 are optional according to utility purposes.

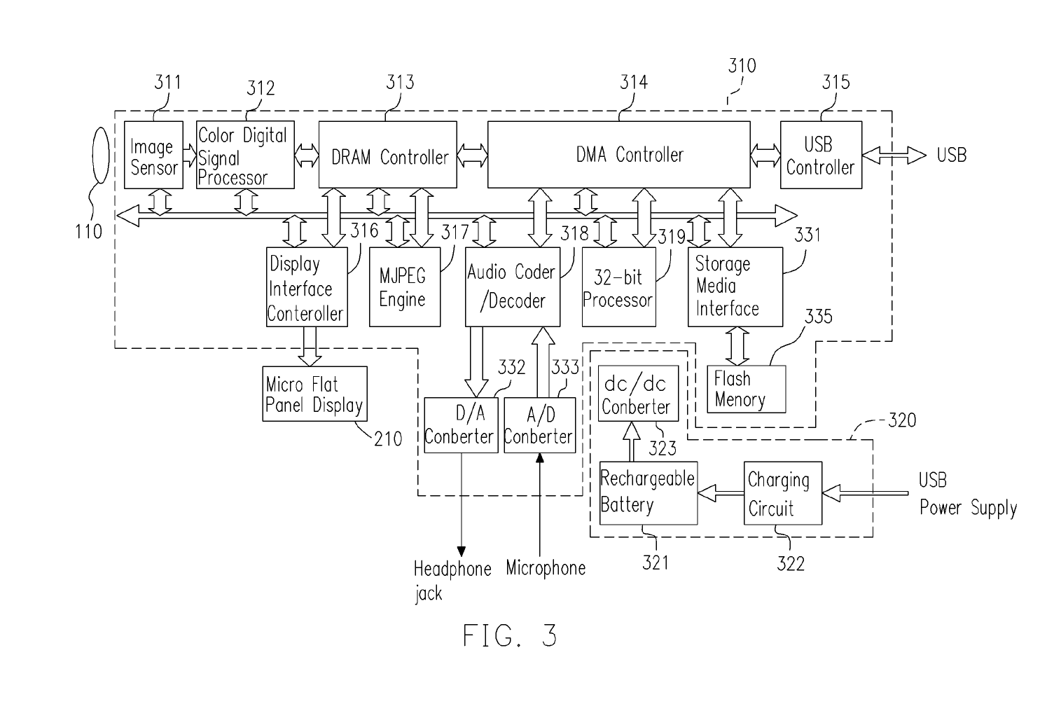

Referring to FIG. 3, a circuit block diagram of this hand-held image capture device according to one preferred embodiment of the invention is illustrated herein. As shown in the diagram, the circuit block diagram of this handheld image capture device comprises an image processing circuit 310 and a power supply circuit 320, which are configured within the body as illustrated in FIGS. 1 and 2.

As illustrated in the diagram, images are captured via an optical lens 110, processed and stored in a flash memory 335 thereafter by the image processing circuit 310, as well as transmitted via USB and USB connector 120 as illustrated in FIG. 1. On the other hand, a micro flat panel display 210 manages to display captured or stored images. As to the power supply circuit 320, it is coupled (the coupling not shown) to the image processing circuit 310 so as to supply power thereof.

Wherein, the image processing 310 comprises an image sensor 311, a color digital signal processor 312, a Dynamic Random Access Memory, or DRAM, a controller 313, a Direct Memory Access, or DMA, controller 314, a USB controller 315, a display interface controller 316, a Moving Joint Photographic Experts Group, or MJPEG, engine 317, an audio encoder/decoder 318, a 32-bit processor 319, a storage media interface 331, a digital/analog converter 332, an analog/digital converter 333, and a flash memory 335 upon different purposes. According to the apparatus illustrated in the figure, the image processing circuit 310 of the handheld image capture device manages to process still images as well as motion images, thus serves as a video camera and/or a camera thereby. Meanwhile, with the audio encoder/decoder 318 and the analog/digital converter 333, the image processing circuit manages to process external audio via the microphone 130 in FIG. 1 so as to serve as a recorder thereby. On the other hand, with the combination of encoder/decoder 318 and the digital/analog converter 332, the apparatus as well serves as a MP3 player via headphone jack 140 in FIG. 1 provided a headset is connected.

Referring to FIG. 3, the power supply circuit 320 comprises a rechargeable battery 321, a charging circuit 322, and a dc/dc converter 323. Wherein, the charging circuit 322 couples to the rechargeable battery 321 and the USB connector 120 in FIG. 1 so as to charge the rechargeable battery 321 via USB power supply in the figure. Whereas the dc/dc converter 323 couples to the rechargeable battery 321 so as to convert voltage level provided by the rechargeable battery 321 to other voltage levels upon elements demand in the image processing circuit 310.

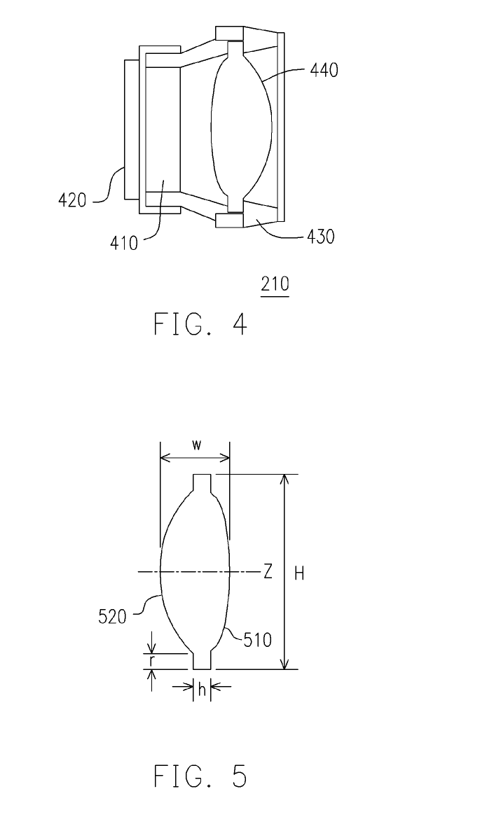

Referring to FIG. 4, a construction diagram of the micro flat panel display of the handheld image capture device is illustrated therein. The micro flat panel display 210 comprises a display 410 featuring a diagonal size of 0.6 inch, which is configured on a Printed Circuit Board, or PCB, 420 thereon. On the other hand, a lens 440, configured in an enclosure 430 of the micro flat panel display 210, spacing apart from the display 410 manages to enlarge the image of the display 410 for a user holding the apparatus for clear observation distance about 8 to 15 cm.

The dimension of the lens 440 in this preferred embodiment is illustrated in FIG. 5. The diameter H measuring about 12 mm, the thickness W to the optic axis Z measuring about 5 mm, the curvature length of inner convex 510 measuring about 15.2 mm, the curvature length of outer convex 520 measuring about 17 mm, and the frame thickness h and radius r measuring about 2 mm respectively. This lens 440, made of glass or plastic materials, is featured a visual angle of 20 degrees. It is apparent to those skilled in the art that various dimensions can feature the lens without departing from the scope or the invention.

According to the foregoing description, the present invention provides at least the following three advantages: 1. For the micro flat panel display serves as a viewfinder for capturing images as well as a display for playing images, the body dimension narrows significantly and power consumption reduces accordingly. 2. A USB connector is featured with the construction, thus neither a cable nor an external stand is needed for direct connection to the USB interface of a computer. 3. Charging is performed via USB power supply as data is transmitted via direct connection with a computer.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A handheld image capture device, comprising:
a body, wherein the body comprises at least an optical lens, a micro flat panel display, and a Universal Serial Bus (USB) connector;
an image processing circuit, configured in the body, for capturing images via the optical lens, processing and storing images via the USB connector that is coupled to a USB, and displaying captured or stored images via the micro flat panel display; and
a power supply circuit, coupled to the image process circuit, for supplying power to the image process circuit.

2. The handheld image capture device as recited in claim 1, wherein the power supply circuit comprises:
a rechargeable battery;
a charging circuit, coupled to the rechargeable battery and the USB connector, for charging the rechargeable battery via power supply to the USB;
a dc to dc converter, coupled to the rechargeable battery, for supplying power to the image processing circuit.

3. The handheld image capture device as recited in claim 1, wherein the micro flat panel display features a diagonal size of 0.6 inch.

4. The handheld image capture device as recited in claim 1, wherein the image processing circuit manages to process motion images so as to serve as a video camera thereof.

5. The handheld image capture device as recited in claim 1, wherein the image processing circuit manages to process still images so as to serve as a camera thereof.

6. The handheld image capture device as recited in claim 1, wherein the body further comprises a microphone, and the image processing circuit manages to process audio so as to serve as a recorder thereof.

7. The handheld image capture device as recited in claim 1, wherein the body further comprises a headphone jack, and the image processing circuit manages to process Moving Pictures Expert Group-1 Audio Layer 3, or MP3, audio so as serve as a MP3 player thereof.

8. A handheld image capture device, comprises:
a body, wherein the body comprises at least an optical lens, a display, and a USB connector;
an image processing circuit, configured in the body, for capturing images via the optical lens, processing and storing images via the USB connector that is coupled to a USB, and displaying captured or stored images via the micro flat panel display;
a rechargeable battery;
a charging circuit, coupled to the rechargeable battery and the USB connector, for charging the rechargeable battery via power supply to the USB; and
a dc to dc converter, coupled to the rechargeable battery, for supplying power to the image processing circuit.

9. The handheld image capture device as recited in claim 8, wherein the display comprises a micro flat panel display.

10. The handheld image capture device as recited in claim 9, wherein the flat panel display features a diagonal size 0.6 inch.

11. The handheld image capture device as recited in claim 8, wherein the image processing circuit manages to process motion images so as to serve as a video camera thereof.

12. The handheld image capture device as recited in claim 8, wherein the image processing circuit manages to process still images so as to serve as a camera thereof.

13. The handheld image capture device as recited in claim 8, wherein the body further comprises a microphone, and the image processing circuit manages to process audio so as to serve as a recorder thereof.

14. The handheld image capture device as recited in claim 8, wherein the body further comprises a head-phone jack, and the image processing circuit manages to process MP3 audio so as serve as a MP3 player thereof.
